(19) United States
(12) Patent Application Publication
(10) Pub. No.: US 2026/0001465 A1
(43) Pub. Date: Jan. 1, 2026

(54) VEHICLE SEAT AND ARMREST THEREOF

(71) Applicant: TACHI-S CO., LTD., Tokyo (JP)

(72) Inventors: Hiroshi FUKUSHIMA, Tokyo (JP); Shogo SUZUKI, Tokyo (JP)

(73) Assignee: TACHI-S CO., LTD., Tokyo (JP)

(21) Appl. No.: 19/249,344

(22) Filed: Jun. 25, 2025

(30) Foreign Application Priority Data
Jun. 28, 2024 (JP) 2024-105065

(51) Int. Cl. B60N 2/75

(52) U.S. Cl. CPC B60N 2/767

(57) ABSTRACT

The present invention provides a structure that: prevents wear of a motor and a gear; reduces time and effort required to replace or repair either the motor or the gear when it is broken due to an excessive input; and facilitates the adjustment in the speed and the motion range of the armrest. An armrest is provided which comprises: an armrest frame attached rotatably about a rotation axis of a seat frame of a seatback; a sector gear integrated with the seat frame; sector gear teeth provided with respect to the sector gear; a motor having a pinion gear meshed with the sector gear teeth; a motor unit including the motor; and a fastening member for fastening the motor unit to the armrest frame.

### BACKGROUND

### Field

The present invention relates to a vehicle seat and an armrest thereof.

### Description of Related Art

As a mechanism for enabling angle adjustment of an armrest attached to a seatback, a mechanism in which an electromotive actuator causes an armrest to pivot around a tilt axis has been proposed (see, for example, JPH06-191337 A).

However, a conventional mechanism is characterized in that a worm gear thereof is relatively prone to wear, and that this leads to low transmission efficiency. When a motor or gear is broken due to, for example, an excessive load being applied on an armrest, time and effort may be required to replace or repair such broken motor or gear. Further, such conventional mechanism can still be considered to be susceptible to improvement from the viewpoint of adjusting the speed and the motion range of an armrest when the armrest is caused to pivot using a motor.

### SUMMARY

In view of the above, an object of the present invention is to provide a vehicle seat having a structure that: prevents wear of a motor and a gear; reduces time and effort required to replace or repair either the motor or the gear when it is broken due to an excessive input; and facilitates the adjustment in the speed and the motion range of the armrest, and to provide an armrest of the vehicle seat.

An aspect of the present invention provides an armrest of a vehicle seat, the armrest comprising:
an armrest frame attached rotatably about a rotation axis of a seat frame of a seatback;
a sector gear integrated with the seat frame;
sector gear teeth provided with respect to the sector gear;
a motor having a pinion gear meshed with the sector gear teeth;
a motor unit including the motor; and
a fastening member for fastening the motor unit to the armrest frame.

When a load is applied on the armrest described above, a load of the moment about the rotation axis of the armrest will work on the armrest. The armrest described above is structured such that the pinion gear of the motor is arranged in a separate position from the rotation axis of the armrest. Thus, this structure prevents the motor and the pinion gear from being broken, compared with a structure in which a pinion gear is arranged on or near a rotation axis. Further, the armrest described above is structured such that the motor unit can be removed from the armrest frame. Thus, even if either the motor or the pinion gear is broken, less time and effort is required to replace or repair the motor or the pinion gear that has been broken. Moreover, the armrest described above is structured so as to pivot through the mesh between the pinion gear on the motor side and the sector gear teeth of the sector gear. Thus, the pivot speed of the armrest can easily be adjusted by adjusting the shape of the sector gear (for example, a distance from the center of rotation to the gear meshing point), and the motion range of the armrest can easily be adjusted by adjusting the number of gear stages or the shape of the sector gear.

In the armrest described above, the pinion gear may be attachable to and detachable from the motor unit.

In the armrest described above, the pinion gear may be attachable to and detachable from the motor unit along an axial direction of the rotation axis.

The armrest described above may further comprise: a sector gear hole provided with respect to the sector gear; and a stopper pin provided with respect to the armrest frame such that part of the stopper pin is engaged with the sector gear hole.

In the armrest described above, the sector gear hole may be provided in an arc shape about the rotation axis.

In the armrest described above, the sector gear may be integrated with the seat frame through a base frame interposed between the armrest frame and the seat frame.

In the armrest described above, the sector gear may be fixed to a shaft part of the base frame.

In the armrest described above, the base frame may be fixed to the seat frame using a bracket that is arranged so as to sandwich the seat frame with the base frame.

The armrest described above may further comprise a switch that normally rotates, reversely rotates, or stops the motor.

In the armrest described above, the switch may be provided in a leading end part of the armrest frame, the leading end part facing in a direction of travel of a vehicle.

The armrest described above may further comprise one or both of an armrest pad and an armrest trim.

Another aspect of the present invention provides a vehicle seat comprising the armrest described above.

### BRIEF DESCRIPTION OF DRAWINGS

FIG. 1 is a perspective view illustrating an example of a vehicle seat.

FIG. 2 is a perspective view of the vehicle seat which illustrates, with solid lines, a structural example of an armrest and other components.

FIG. 3 is a side view of the vehicle seat illustrated in FIG. 2, which is seen from the left side.

FIG. 4 is a side view of the vehicle seat when an armrest is caused to pivot upward.

FIG. 5 is a side view illustrating an example of an internal structure of the armrest.

FIG. 6 is an enlarged view illustrating the internal structure of the armrest.

FIG. 7 is a view illustrating a structure of an area around a sector gear in a state in which a motor unit has been removed.

FIG. 8 is an exploded perspective view illustrating internal structures of the armrest and its surroundings.

FIG. 9 is a view illustrating a structural example of an armrest frame and other components.

FIG. 10 is an enlarged view illustrating an area indicated by a two-dot chain line shown in FIG. 9.

FIG. 11 is a cross-sectional view taken along a line XI-XI shown in FIG. 10.

FIG. 12 is an exploded perspective view illustrating an armrest frame, an armrest pad and an armrest trim.

### DETAILED DESCRIPTION

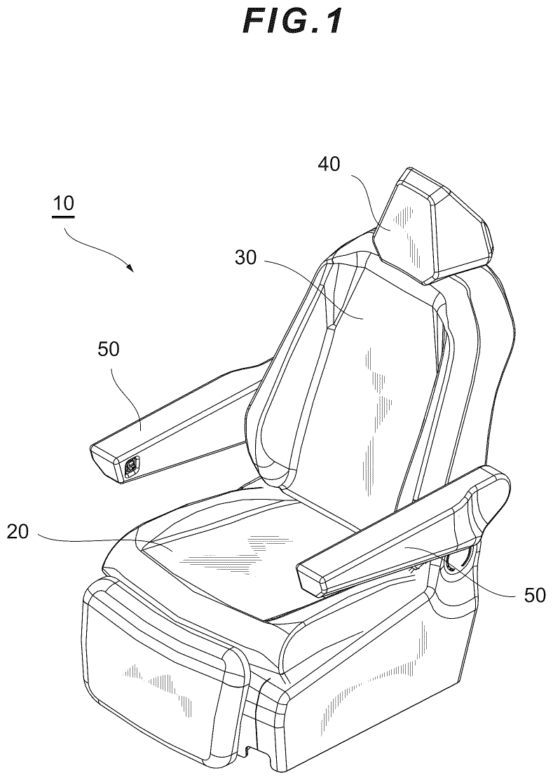

A preferred embodiments of the present invention will now be described in detail while referring to the attached drawings (see FIGS. 1 to 12).

### Vehicle Seat

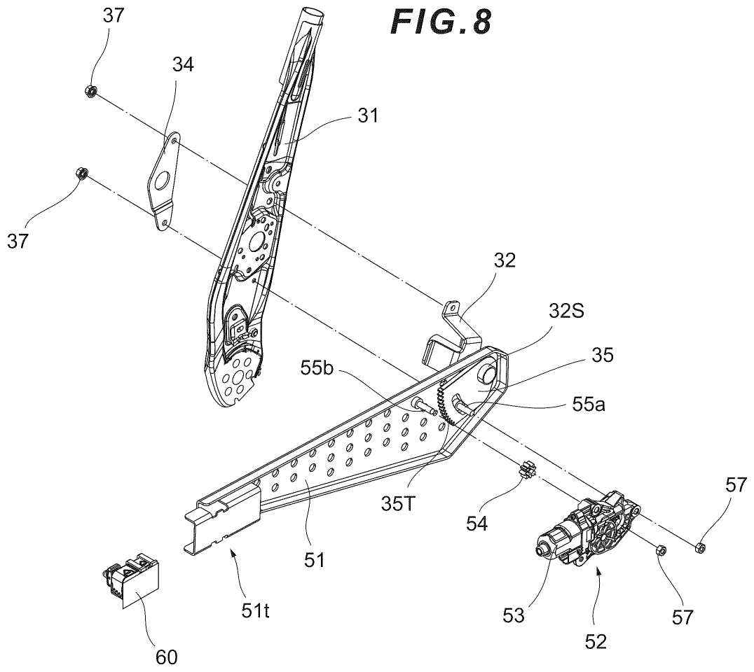

A vehicle seat 10 is a seat that is placed in a vehicle, such as an automobile. The vehicle seat 10 comprises: a seat cushion 20, which supports the buttocks and thighs of a seated occupant; a seatback 30, which supports the waist and back of the occupant; a head rest 40, which supports the head of the occupant; and an armrest 50, which supports the wrists, elbows, etc. of the occupant (see FIGS. 1 to 4). The seat cushion 20 and the seatback 30 each include a seat frame that forms a framework of either the seat cushion 20 or the seatback 30 (in FIG. 8, etc., only a back side frame of the seat frame, such back side frame forming a framework of a side of the seatback 30, is illustrated as a seat frame 31). The seat frame 31 is covered by a seat pad formed of a relatively soft resin forming material, such as a urethan form, and is further covered by a trim cover formed of a skin material, such as leather, woven fabric or nonwoven fabric.

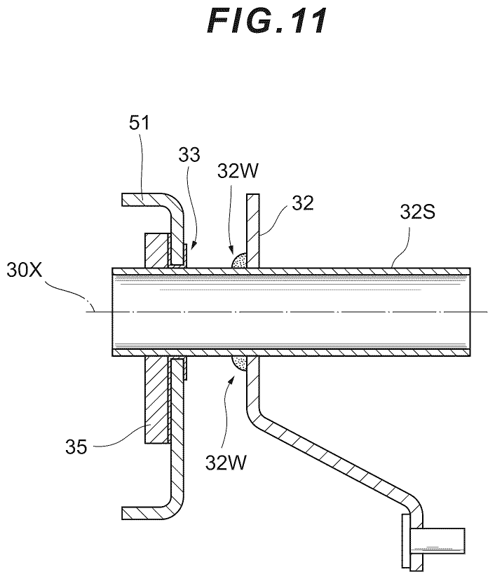

A base frame 32, which supports the armrest 50, is fixed to a side of the seat frame (back side frame) 31 (see FIG. 8, etc.). The base frame 32 is provided with a shaft part 32S, part of which protrudes laterally outward of the base frame 32 (in an outward direction). The shaft part 32S is constituted by, for example, a pipe that is fixed to the base frame 32 via welding (the welded portion is indicated by reference symbol 32w in FIG. 11). The shaft part 32S supports an armrest frame 51 rotatably about a rotation axis 30X (see FIG. 11, etc.). A bracket 34 is provided inside the side of the seat frame (back side frame) 31 (in a direction facing the center with respect to a width direction of the vehicle seat 10). The bracket 34 is arranged so as to sandwich the seat frame 31 with the base frame 32 and is fixed to the seat frame 31 by a fastening member, such as nuts 37 (see FIG. 8).

### Armrest

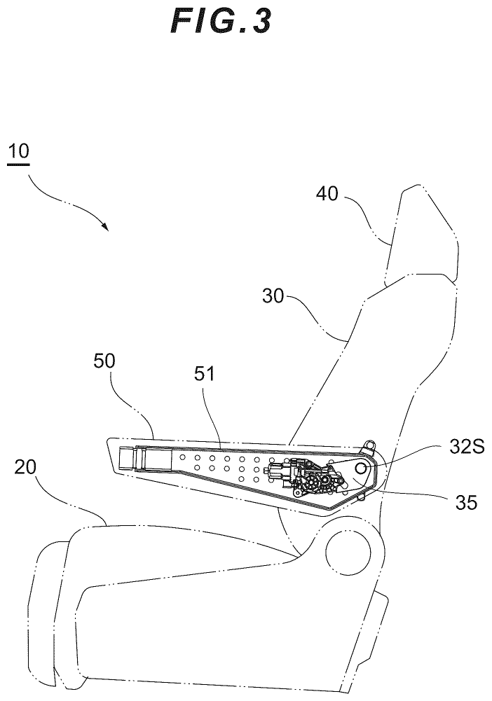

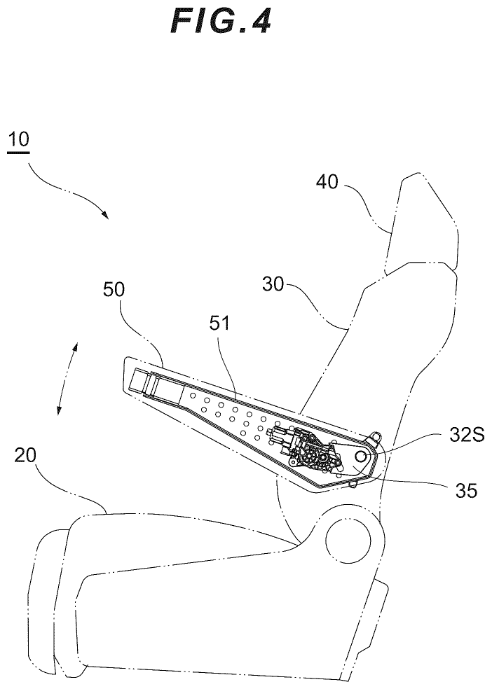

The armrest 50 in the vehicle seat 10 according to the present invention is provided so as to be capable of vertically pivoting about the rotation axis 30X (see FIGS. 3, 4, etc.). The armrest 50 of the present embodiment comprises the armrest frame 51, a sector gear 35, a motor unit 52, nuts 57, a switch 60, etc. (see FIG. 8, etc.).

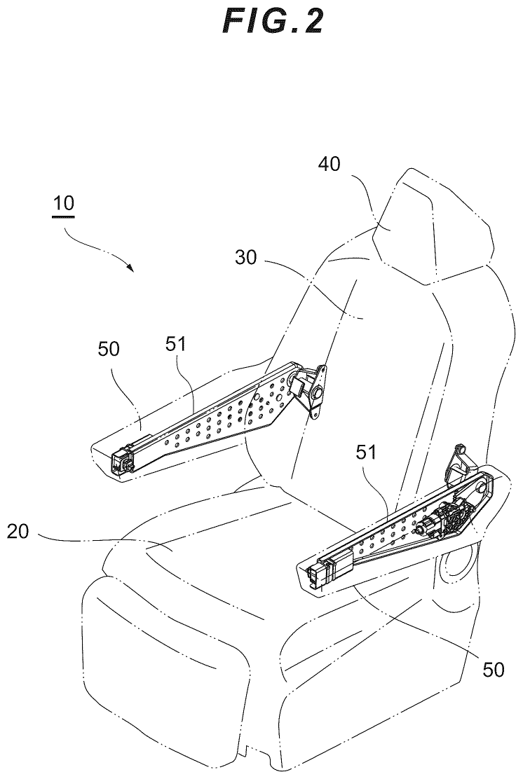

The armrest frame 51 is a frame that forms a framework of the armrest 50. The armrest frame 51 of the present embodiment is attached, through a bush bearing 33, to the shaft part 32S, which has been welded with respect to the base frame 32, and is supported rotatably about the rotation axis 30X (see FIGS. 2, 8, etc.). The armrest frame 51 is provided with a stopper pin 55a, which protrudes outward and is inserted through and engaged with a sector gear hole 35H of the sector gear 35 (see FIG. 8, etc.).

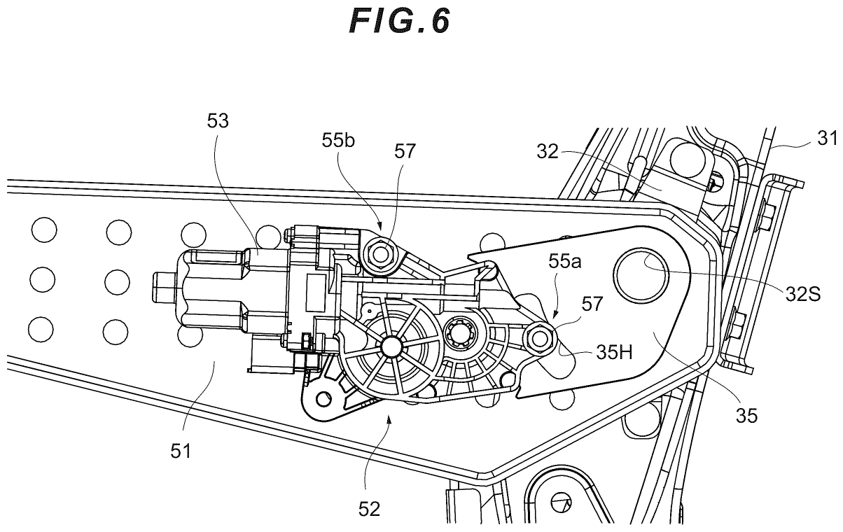

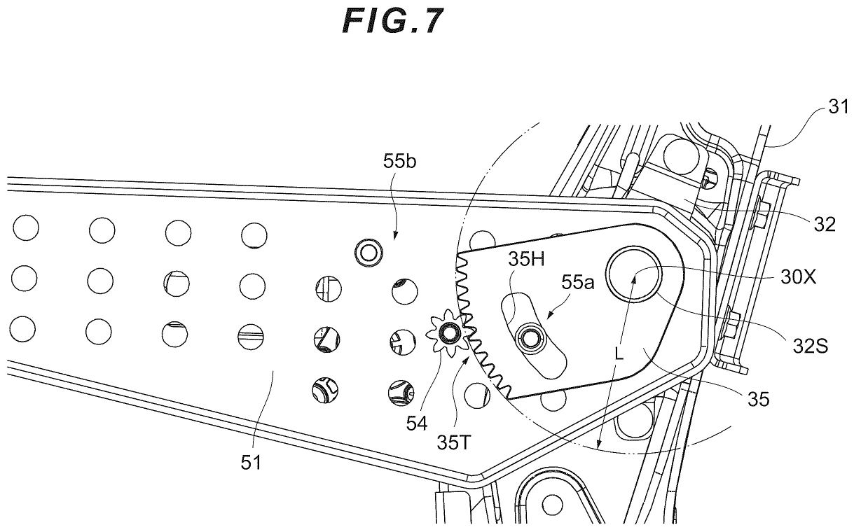

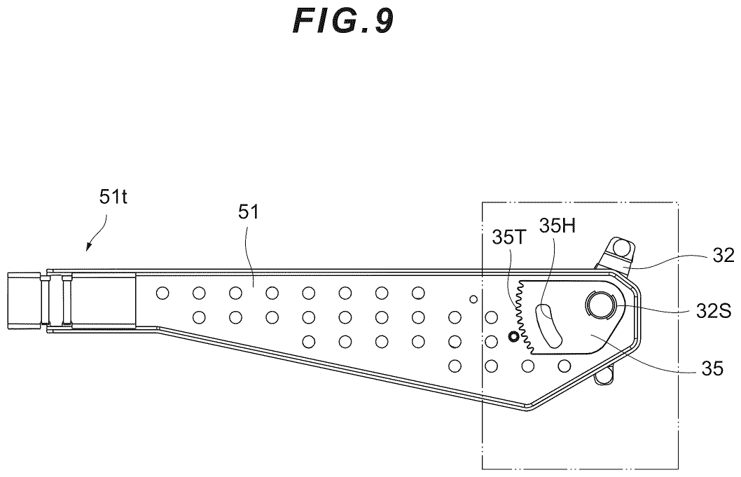

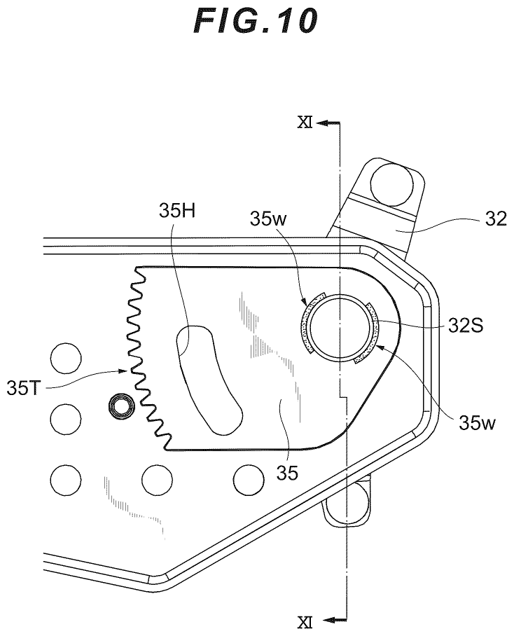

The sector gear 35 is a plate member provided with sector gear teeth 35T and the sector gear hole 35H (see FIG. 9), and the sector gear 35 is fixed to the shaft part 32S via, for example, welding (the welded portion is indicated by reference symbol 35w in FIG. 10) and integrated with the seat frame 31 through the base frame 32. The sector gear teeth 35T are formed in an arc shape about the rotation axis 30X (see FIG. 10, etc.). The sector gear hole 35H is formed in an arc shape about the rotation axis 30X such that the stopper pin 55a is inserted through and engaged with the sector gear hole 35H (see FIG. 8, etc.). When the armrest 50 vertically pivots about the rotation axis 30X (see FIGS. 3 and 4), the stopper pin 55a, which is provided with respect to the armrest frame 51, also pivots vertically, and the stopper pin 55a is restricted from moving as it abuts against an end of the sector gear hole 35H. In this way, the sector gear hole 35H functions as a stopper that regulates a pivot width of the armrest frame 51 and the armrest 50 through the stopper pin 55a (see FIGS. 6 and 7).

The motor unit 52, which is a unit for driving the armrest 50, comprises a motor 53 and a pinion gear 54 and is attachable to and detachable from the armrest frame 51 (see FIG. 8). The pinion gear 54 is arranged so as to be meshed with the sector gear teeth 35T of the sector gear 35 (see FIGS. 6 and 7). When the motor 53 rotationally drives the pinion gear 54, the pinion gear 54 moves while rotating along the sector gear teeth 35H of the sector gear 53, whereby the armrest frame 51 and the armrest 50 pivot in a vertical direction (see FIGS. 4, 6, etc.). The motor unit 52 of the present embodiment is attached to the armrest frame 51 by screwing the nuts 57 with a screw part (not shown) of the stopper pin 55a, which extends in an axial direction of the rotation axis 30X, and with a screw part (not shown) of a pin 55b, which is provided together with the stopper pin 55a (see FIG. 8), and the motor unit 52 can be attached to and detached from the armrest frame 51 relatively easily by being removed and inserted along axial directions of the stopper pin 55a and the pin 55b. The stopper pin 55a, the pin 55b and the nuts 57 described herein are merely examples of fastening members, and bolts and the like may also be used as a matter of course.

The pinion gear 54 is attachable to and detachable from the motor unit 52 (see FIG. 8). The pinion gear 54 in the armrest 50 of the present embodiment is attachable to and detachable from the motor unit 52 along a direction that is the same as the axial directions of the stopper pin 55a and the pin 55b and, in turn, along the axial direction of the rotation axis 30X, indicating that the pinion gear 54 has a structure which allows a worker, etc. to easily perform detachment and attachment work from a visual and sensory perspective. As a result, it is relatively easy to perform replacement and repair work, such as work of substituting the pinion gear 54 that is broken, and this leads to less time and effort being needed.

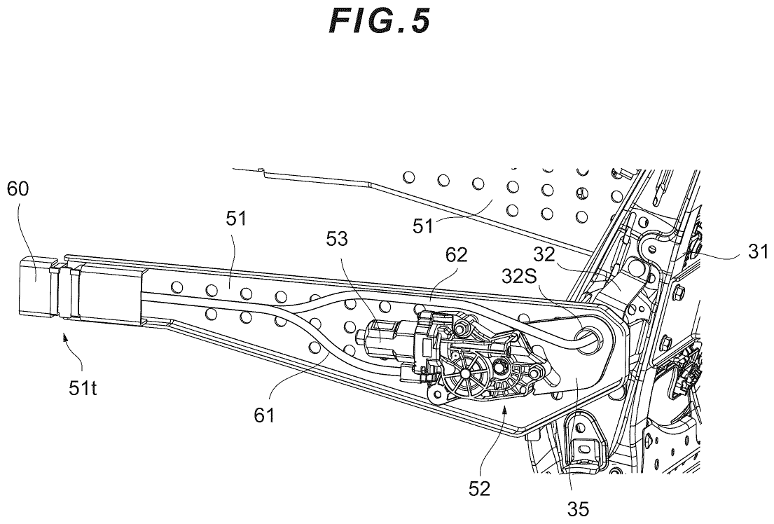

The switch 60 is an input device that normally or reversely rotates and further stops the motor 53 and thereby causes the armrest 50 to move vertically (to pivot) with respect to a desired height, and the switch 60 is positioned such that it is easy for an occupant to manipulate the switch 60. For example, the switch 60 in the armrest 50 of the present embodiment may be provided in a leading end part 51t of the armrest frame 51, wherein such leading end part 51t faces in a direction of travel of the vehicle, and the occupant is allowed to easily manipulate the switch 60 while keeping his/her arm on the armrest 50 (see FIGS. 5 and 8). The switch 60 and the motor 53 are connected through a harness 61 wired along the armrest frame 51 (see FIG. 5). A harness 62 passes through the shaft part 32S, which is integrated with the sector gear 35, and is connected to a main harness (not shown) of the vehicle seat 10.

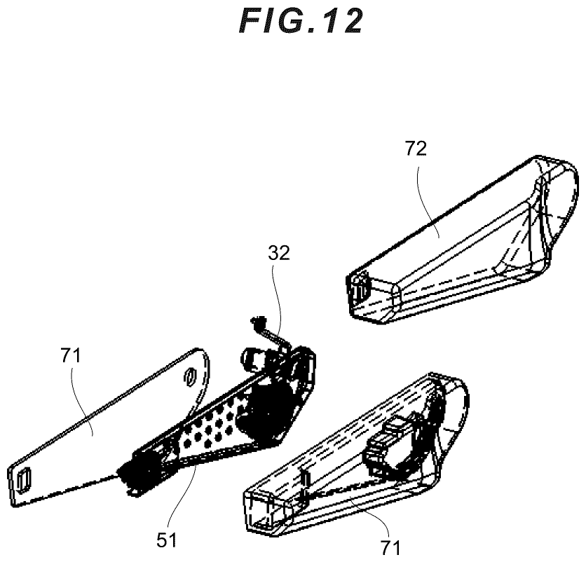

The armrest 50 of the present embodiment further comprises an armrest pad 71 and an armrest trim 72 (see FIG. 12). The armrest pad 71 has a structure of two components that are respectively provided inside and outside of the armrest frame 51. The armrest pad 71 may also be a structure of one component only, and in such case, the armrest pad 71 may be provided with a slit on the underside thereof, and such armrest pad 71 may be assembled with the armrest frame 51 from the top thereof. In place of using the armrest pad 71, a resin cover may be used to cover the armrest frame 51.

The above-described armrest 50 of the present embodiment is structured so as to easily prevent the motor 53 from being broken. Namely, when, for example, an occupant putting his/her arm on the armrest 50 applies an excessive load on the armrest 50, a load of the moment about the rotation axis 30X will work on the armrest 50. In this regard, the present embodiment is structured such that the pinion gear 54 of the motor 53 is arranged in a separate position from the rotation axis 30X by a size of the sector gear 35 (more precisely, a distance L from the rotation axis 30X to the sector gear teeth 35T) (see FIG. 7). Thus, this structure is capable of preventing an external force from directly working on the motor 53 and the pinion gear 54, compared with a structure in which a pinion gear 54 is arranged on a rotation axis 30X (in other words, a structure in which an output axis of a motor is directly connected, on the same line, with a pivot axis of an armrest), so that the sector gear 35 can bear a load, which makes it easy to prevent the motor 53 and the pinion gear 54 from being broken.

The armrest 50 of the present embodiment is structured such that the motor unit 52 is easily removed from and attached to the armrest frame 51. Thus, even if either the motor 53 or the pinion gear 54 is broken, less time and effort is required to replace or repair the motor 53 or the pinion gear 54 that has been broken.

The armrest 50 of the present embodiment is structured so as to pivot through the mesh between the pinion gear 54 on the motor 53 side and the sector gear teeth 35T of the sector gear 35. Thus, the pivot speed of the armrest 50 can be adjusted by changing, for example, the distance L from the rotation axis 30X to the sector gear teeth 35T. Further, the motion range of the armrest 50 can be adjusted by changing the number of gear stages or the shape of the sector gear 35, or by changing the positions and the shapes of the stopper pin 55a and the sector gear hole 35H.

Although the embodiment described above is merely one example of a preferred embodiment, the present invention is not limited thereto, and various modifications may be made without departing from the gist of the present invention. For example, the above-described embodiment has discussed the armrest 50 located on the left side of the vehicle seat 10; however, this is just an example, and a structure that is symmetrical to that of the left armrest 50 is applicable to the armrest 50 located on the right side of the vehicle seat 10.

The present invention provides a vehicle seat having a structure that: prevents wear of a motor and a gear; reduces time and effort required to replace or repair either the motor or the gear when it is broken due to an excessive input; and facilitates the adjustment in the speed and the motion range of the armrest, and also provides an armrest of the vehicle seat.

The present invention is suited to be applied to a vehicle seat and to an armrest thereof.

What is claimed is:

1. An armrest of a vehicle seat, the armrest comprising:
an armrest frame attached rotatably about a rotation axis of a seat frame of a seatback;
a sector gear integrated with the seat frame;
sector gear teeth provided with respect to the sector gear;
a motor having a pinion gear meshed with the sector gear teeth;
a motor unit including the motor; and
a fastening member for fastening the motor unit to the armrest frame.

2. The armrest according to claim 1, wherein the pinion gear is attachable to and detachable from the motor unit.

3. The armrest according to claim 2, wherein the pinion gear is attachable to and detachable from the motor unit along an axial direction of the rotation axis.

4. The armrest according to claim 1, further comprising: a sector gear hole provided with respect to the sector gear; and a stopper pin provided with respect to the armrest frame such that part of the stopper pin is engaged with the sector gear hole.

5. The armrest according to claim 4, wherein the sector gear hole is provided in an arc shape about the rotation axis.

6. The armrest according to claim 1, wherein the sector gear is integrated with the seat frame through a base frame interposed between the armrest frame and the seat frame.

7. The armrest according to claim 6, wherein the sector gear is fixed to a shaft part of the base frame.

8. The armrest according to claim 7, wherein the base frame is fixed to the seat frame using a bracket that is arranged so as to sandwich the seat frame with the base frame.

9. The armrest according to claim 1, further comprising a switch that normally rotates, reversely rotates, or stops the motor.

10. The armrest according to claim 9, wherein the switch is provided in a leading end part of the armrest frame, the leading end part facing in a direction of travel of a vehicle.

11. The armrest according to claim 1, further comprising one or both of an armrest pad and an armrest trim.

12. A vehicle seat comprising the armrest according to claim 1.
